(19) United States
(12) Patent Application Publication
(10) Pub. No.: US 2014/0297805 A1
(43) Pub. Date: Oct. 2, 2014

(54) METHOD AND APPARATUS FOR ASSIGNING PRIORITY LEVELS TO STREAMS BY A NETWORK ELEMENT IN A COMMUNICATIONS NETWORK

(71) Applicants: Amit CHAPLOT, Bangalore (IN); Frederic SPIESER, Calabasas, CA (US); Abhishek SINHA, Calabasas, CA (US); Peter OTT, Atlantic Highlands, NJ (US)

(72) Inventors: Amit CHAPLOT, Bangalore (IN); Frederic SPIESER, Calabasas, CA (US); Abhishek SINHA, Calabasas, CA (US); Peter OTT, Atlantic Highlands, NJ (US)

(73) Assignees: ALCATEL-LUCENT INDIA LIMITED, Gurgaon (IN); ALCATEL-LUCENT USA INC., Murray Hill, NJ (US)

(21) Appl. No.: 13/853,627

(22) Filed: Mar. 29, 2013

(51) Int. Cl. H04L 12/851; H04L 29/06

(52) U.S. Cl. CPC H04L 47/24; H04L 65/608
USPC 709/219

(57) ABSTRACT

A method for assigning a priority level to a stream by a network element in a communications network, where the network element has a plurality of communications ports is disclosed. The method includes monitoring at least one of the ports for at least one stream being communicated between a first user agent and a second user agent during a Session Initiation Protocol (SIP) communication session. The SIP communication session includes a plurality of SIP packets. The network element captures at least one SIP packet of the plurality of SIP packets and extracts information from the at least one captured SIP packet to determine a service type of the at least one stream. The network element assigns a priority level to the at least one stream based on the service type and according to a policy that defines priority levels for streams according to a plurality of service types.

### BACKGROUND

Newly developed software applications and hardware devices, and their need for network resources, keep demand on networks high. Additionally, elastic traffic like TCP-based non-real time traffic tends to use any additional available bandwidth. However, network technologies cannot always grow or adapt at a pace that is fast enough to address the bandwidth requirements of these newly developed applications and devices. Therefore, it is up to network administrators to organize and monitor their networks such that network resources are conserved. In order to conserve network resources, it is helpful to differentiate between different types of network traffic or streams (i.e., video, voice, and/or mission critical data) and to provide applicable quality of service (QoS) treatments for each stream type.

Still, it may be difficult for network administrators to differentiate between stream types and to provide applicable quality of service (QoS) treatments for each stream type. Currently, network administrators can configure network devices to apply a general QoS treatment to streams that enter or leave the network device. However, this method leads to similar QoS treatments being applied to more than one type of stream.

### SUMMARY

Example embodiments provide systems and/or methods for assigning priority levels to streams and applying QoS treatments to streams according at least to service type.

According to an example embodiment, a method for assigning a priority level to a stream by a network element in a communications network, where the network element has a plurality of communications ports, includes monitoring at least one of the ports for at least one stream being communicated between a first user agent and a second user agent during a Session Initiation Protocol (SIP) communication session. The SIP communication session includes a plurality of SIP packets. The network element captures at least one SIP packet of the plurality of SIP packets and extracts information from the at least one captured SIP packet to determine a service type of the at least one stream. The network element assigns a priority level to the at least one stream based on the service type and according to a policy that defines priority levels for streams according to a plurality of service types.

In one example embodiment, the method may include one of terminating and throttling the at least one stream based on the service type and according to the policy.

According to another example embodiment, the method may include extracting quality of service (QoS) information from the stream to determine a QoS value. The QoS value may be measured according to the service type of the stream.

According to another example embodiment, the method may further include flagging the stream if the QoS value falls below a predefined threshold.

According to another example embodiment, the QoS information may be associated with a QoS type, where the QoS type may be one of a delay, a jitter, a round trip time (RTT), an R-factor, and a mean opinion score (MOS). The R-factor and MOS each may be a measure of voice quality during the SIP session. The RTT may be a sum of a measure of time for at least one packet sent by the network element to be received by a user agent and a measure of time for an acknowledgement message sent by the user agent to be received by the network element.

According to another example embodiment, each SIP packet of the plurality of SIP packets may comprise a tuple whose values include a source IP address, a destination IP address, a transport protocol, a transport source port number, and a transport destination port number.

According to another example embodiment, the method may include overriding the priority of the stream and assigning a new priority to the stream based on at least one tuple value and the service type. The new priority may be assigned according to the policy.

According to another example embodiment, the policy may be created and maintained by a network administrator. Additionally, the service type may be one of an audio, video, data, and dual-tone multi-frequency signaling (DTMF). Furthermore, the stream may be formatted according to the Real-time Transport Protocol (RTP).

Another example embodiment provides a network device that is part of a communications network and has a plurality of communications ports configured to monitor at least one of the plurality of ports for a stream being communicated between a first user agent and a second user agent during a Session Initiation Protocol (SIP) communication session, the SIP communication session includes a plurality of SIP packets. The network element may be configured to capture at least one SIP packet of the plurality of SIP packets and extract information from at least one SIP packet of the plurality of packets to determine a service type of the stream. The network device may be configured to assign a priority level to the stream based on the service type and according to a policy that defines priority levels for streams according to a plurality of service types.

In one example embodiment, the network device may be configured to terminate or throttle the at least one stream based on the service type and according to the policy.

According to another example embodiment, the network device may be configured to extract QoS information from the stream to determine a QoS value. The QoS value may be measured according to the service type of the stream.

According to another example embodiment, the network device may be configured to flag the stream when the QoS value falls below a predefined threshold.

According to another example embodiment, each of the plurality of QoS values may be associated with a QoS type. The QoS type may be one of a delay, a jitter, a round trip time (RTT), an R-factor, and a mean opinion score (MOS). The R-factor and MOS may each be a measure of voice quality during the SIP session. The RTT may be a sum of a measure of time for at least one packet sent by the network element to be received by a user agent and a measure of time for an acknowledgement message sent by the user agent to be received by the network element.

According to another example embodiment, each SIP packet of the plurality of SIP packets may comprise a tuple that includes a source IP address, a destination IP address, a transport protocol, a transport source port number, and a transport destination number.

According to another example embodiment, the network device may be configured to override the priority of the stream and assign a new priority to the stream based on at least one tuple value and the service type. The new priority may be assigned according to the policy.

According to another example embodiment, the policy may be created and maintained by a network administrator. Additionally, the service type may be one of an audio, video, data, and dual-tone multi-frequency signaling (DTMF). Furthermore, the stream may be formatted according to the Real-time Transport Protocol (RTP).

### BRIEF SUMMARY OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an example of a communications network, according to an example embodiment; and

FIG. 2 illustrates the components of a network device being employed by a communication network according to an example embodiment;

FIG. 3 illustrates a Session Initiation Protocol (SIP) message according to an example embodiment; and

FIG. 4 shows a SIP snooping routine according to an example embodiment.

### DETAILED DESCRIPTION OF THE EMBODIMENTS

Various example embodiments will now be described more fully with reference to the accompanying drawings in which some example embodiments of the invention are shown.

Detailed illustrative embodiments are disclosed herein. However, specific structural and functional details disclosed herein are merely representative for purposes of describing example embodiments of the present invention. This invention may, however, may be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used herein, the term “user agent” may be considered synonymous to, and may hereafter be occasionally referred to, as a client, mobile, mobile unit, mobile station, mobile user, user equipment (UE), subscriber, user, remote station, access agent, user agent, receiver, etc., and may describe a remote user of network resources in a communications network. Furthermore, the term “user agent” may include any type of wireless/wired device such as consumer electronics devices, smart phones, tablet personal computers, personal digital assistants (PDAs), desktop computers, and laptop computers, for example.

As used herein, the term “network device”, may be considered synonymous to and/or referred to as a networked computer, networking hardware, network equipment, router, switch, hub, bridge, gateway, or other like device. The term “network device” may describe a physical computing device of a wired or wireless communication network and configured to host a virtual machine. Furthermore, the term “network device” may describe equipment that provides radio baseband functions for data and/or voice connectivity between a network and one or more users.

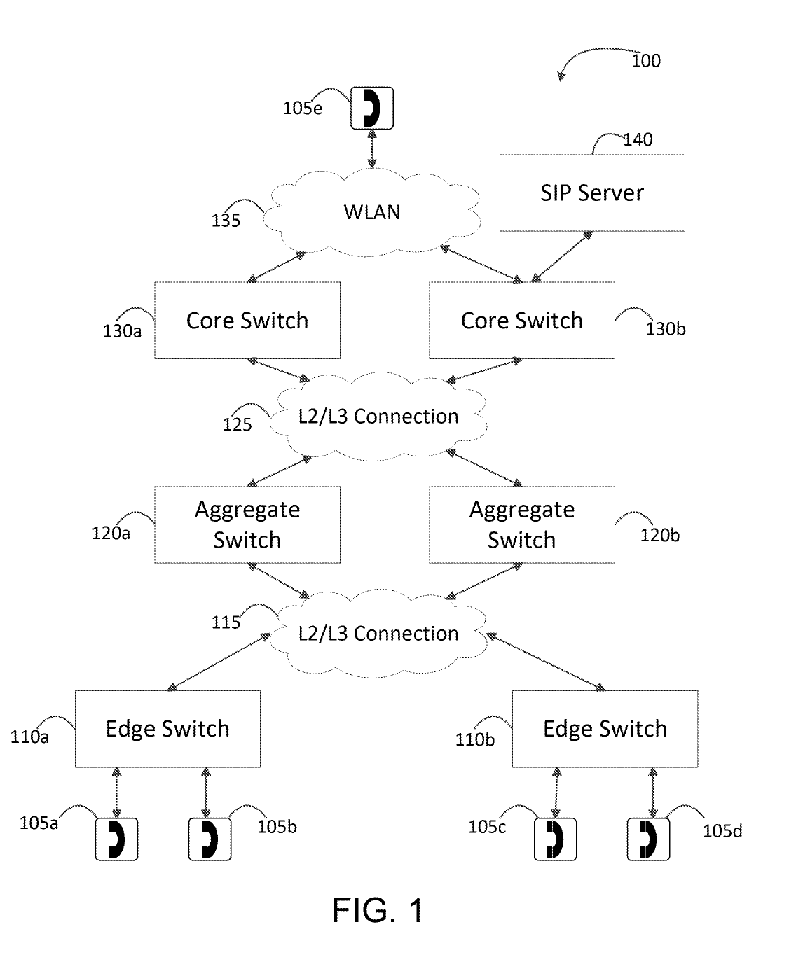

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular data types. The program modules and functional processes discussed herein may be implemented using existing hardware in existing communication networks. For example, program modules and functional processes discussed herein may be implemented using existing hardware at existing network elements or control nodes (e.g., an edge switch, aggregate switch, or core switch as shown in FIG. 1). Such existing hardware may include one or more digital signal processors (DSPs), application-specific-integrated-circuits, field programmable gate arrays (FPGAs) computers or the like.

FIG. 1 illustrates an example of a communications network, according to an example embodiment. A communications network 100 includes user agents 105a-e, edge switches 110a-b, L2/L3 connection 115, aggregate switches 120a-b, L2/L3 connection 125, core switches 130a-b, WLAN 135, and SIP server 140.

Each of the user agents 105a-e may include memory and one or more processors, in addition to a transceiver. User agents 105a-e may be configured to send/receive data to/from network devices, such as edge switch 110a-b, via a wired or wireless connection. User agents 105a-e may also be configured to send/receive data to/from aggregate switches 120a-b and/or core switches 130a-b (not shown). User agents 105a-e may be designed to sequentially and automatically carry out a sequence of arithmetic or logical operations; equipped to record/store digital data on a machine readable medium; and transmit and receive digital data via one or more network devices. User agents 105a-e may include devices such as cellular phones, tablet personal computers, desktop computers, laptop computer, and/or any other physical or logical device capable of recording, storing, and/or transferring digital data via a connection to a network device. Each of the user agents 105a-e may include a wireless transceiver configured to operate in accordance with the IEEE 802.11-2007 standard (802.11) or other like wireless standards. Alternatively, user agents 105a-e may include analog telephones, which may connect to a network device utilizing an analog telephone adapter (such devices are known in the art).

Edge switches 110a-b, aggregate switches 120a-b, and core switches 130a-b (“the switches”) may be configured to provide communication services to user agents operating within a computer network (e.g., an enterprise private network, virtual private network, local area network (LAN), or other like computer network). The switches may also link network segments or other network devices within a computer network. Additionally, in some embodiments, the switches may be configured as virtual local area networks (VLAN). In such embodiments, one or more of the switches may be partitioned to create multiple distinct broadcast domains, which are logically isolated from one another while remaining on the same physical switch.

The switches may be configured to process and route data (or data packets) at the data link layer (layer 2) of the OSI model, and/or process data (or data packets) at the network layer (layer 3) (i.e., the switches may be considered “multilayer switches”). For example, each one of the switches may be an OmniSwitch™ as provided by Alcatel-Lucent Enterprises.

The switches may employ multiple connection interfaces in order to allow different user agent devices to connect to a communications network, including Ethernet, Fibre Channel, ATM, ITU-T, G.hn, 802.11, and/or other like connection interfaces.

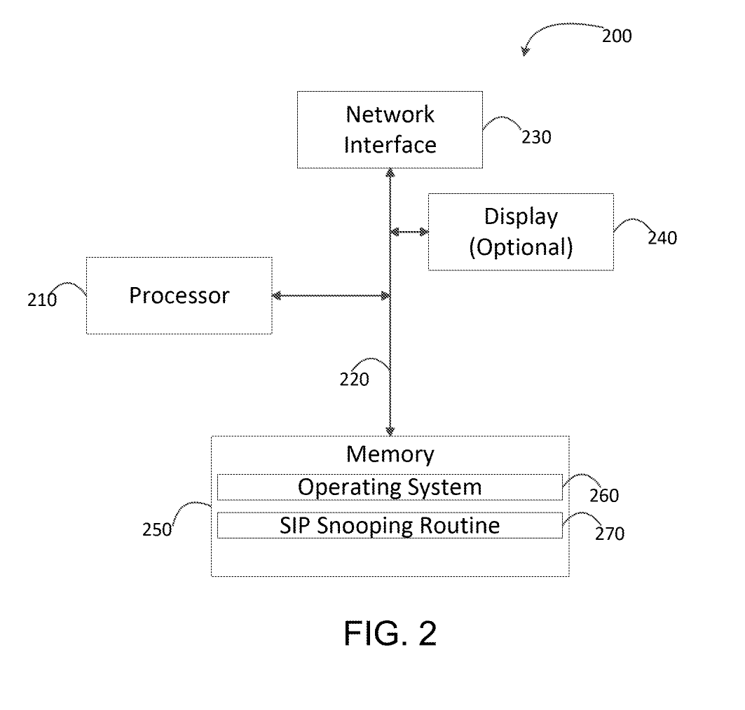

The switches may include one or more processors, a network interface including one or more transmitters/receivers connected to one or more antennas, a computer readable medium, and (optionally) a display device (see e.g., FIG. 2 as discussed below). The one or more transmitters/receivers may be configured to transmit/receive data signals to/from one or more user agents.

For example, FIG. 1 shows user agents 105a linked to edge switch 110a. The link between user agent 105a and edge switch 110a may be wired (e.g., using an Ethernet cable), or wireless (e.g., using the 802.11 protocol). In this instance, edge switch 110a may be configured to receive one or more data packets from user agent 105a and transmit the one or more data packets to a device for which the message was meant (e.g., user agent 105e).

L2/L3 connections 115 and 125 may be configured to connect two or more devices at the datalink layer (L2) and/or the network layer (L3) of the OSI model. L2/L3 connections 115 and 125 may operate as an enterprise private network, virtual private network, local area network (LAN), or other like computer network.

An L2 connection may employ a protocol for providing the functional and procedural means to transfer data between network entities. Such protocols may include Ethernet, Point-to-Point Protocol (PPP), High Level Data Link Control (HDLC), or other like protocols already known in the art.

An L3 connection may employ a protocol for providing the functional and procedural means of transferring variable length data sequences from a source to a destination host via one or more networks while maintaining quality of service (QoS) functions. Such protocols may include Internet Protocol version 4 (IPv4), Internet Protocol version 6 (IPv6), or other like protocols already known in the art.

WLAN 135 may be configured to link two or more devices using a wireless distribution method, such as spread-spectrum, orthogonal frequency-division multiplexing (OFDM), or other like wireless distribution method. WLAN 135 may be configured to provide a connection to the Internet for various network elements (e.g., user agents 105a-d via edge switches 110a-b, aggregate switches 120a-b, and core switches 130a-b). In various embodiments, WLAN 135 may be a Wide Area Network (WAN) or other like network that covers a broad area, such as a personal area network (PAN), local area network (LAN), campus area network (CAN), metropolitan area network (MAN), and the like.

SIP server 140 may include a server (i.e., a physical computer hardware system) that is configured to provide services for users connected to a network. SIP server 140 may employ connection-oriented protocols such as Session Initiation Protocol (SIP), HTTP, and TCP/IP, and includes servers that use connectionless protocols such as User Datagram Protocol (UDP) and Internet Packet Exchange (IPX). SIP server 140 may be configured to establish, manage, and terminate SIP communications sessions between user agents (e.g., user agents 105a-e). SIP server 140 may be configured to register one or more SIP user agents by registering each IP address associated with each SIP user agent, respectively, and assigning a unique ID to each SIP user agent. To this end, SIP server 140 may be configured to receive/send communication requests from/to user agents, as well as correlate the unique IDs of the user agents with an IP address of the user agents, and once a communication session is setup, allowing two user agents to transfer data using a direct peer-to-peer session.

For example, user agent 105a may wish to initiate a communication session, such as a voice call, with user agent 105e. In this instance, user agent 105a may send a communication request (including the unique ID of user agent 105e) to SIP server 140, via edge switch 110a, aggregate switch 120a, and core switch 130b. SIP server 140 may then correlate the unique ID of user agent 105e with an IP address of user agent 105e, and then forward the communication request to the user agent 105e, via core switch 130b. User agent 105e may be informed of the communication request when her terminal rings. Upon receipt of the communication request by user agent 105e, user agent 105a and user agent 105e setup a communication session. Once the communication session is setup, the two clients transfer data using a direct peer-to-peer session. Such a session may include, for example, a RTP/RTCP voice channel. Once the communication session is terminated, the RTP/RTCP channel may also be released.

FIG. 2 illustrates the components of network device 200 that may be employed by a communication network according to an example embodiment. It should be noted that any one of the network devices as shown in FIG. 1 (e.g., edge switches 110a-b, aggregate switches 120a-b, and core switches 130a-b) may have a similar configuration of components as shown in FIG. 2. As shown, network device 200 includes processor 210, bus 220, network interface 230, optional display 240, and memory 250. During operation, memory 250 includes operating system 260 and SIP snooping routine 270. In some embodiments, network device 200 may include many more components than those shown in FIG. 2. However, it is not necessary that all of these generally conventional components be shown in order to disclose the illustrative embodiment.

Memory 250 may be a computer readable storage medium that generally includes a random access memory (RAM), read only memory (ROM), and a permanent mass storage device, such as a disk drive. Memory 250 also stores operating system 260 and program code for SIP snooping routine 270. These software components may also be loaded from a separate computer readable storage medium into memory 250 using a drive mechanism (not shown). Such separate computer readable storage medium may include a floppy drive, disc, tape, DVD/CD-ROM drive, memory card, or other like computer readable storage medium (not shown). In some embodiments, software components may be loaded into memory 250 via network interface 230, rather than via a computer readable storage medium.

Processor 210 may be configured to carry out instructions of a computer program by performing the basic arithmetical, logical, and input/output operations of the system. Instructions may be provided to processor 210 by memory 250 via bus 220.

Bus 220 enables the communication and data transfer between the components of network device 200. Bus 220 may comprise a high-speed serial bus, parallel bus, storage area network (SAN), and/or other suitable communication technology.

Network interface 230 is a computer hardware component that connects network device 200 to a computer network (e.g., L2/L3 connections 115 and 125 and/or WLAN 135). Network interface 230 may connect network device 200 to a computer network via a wired or wireless connection.

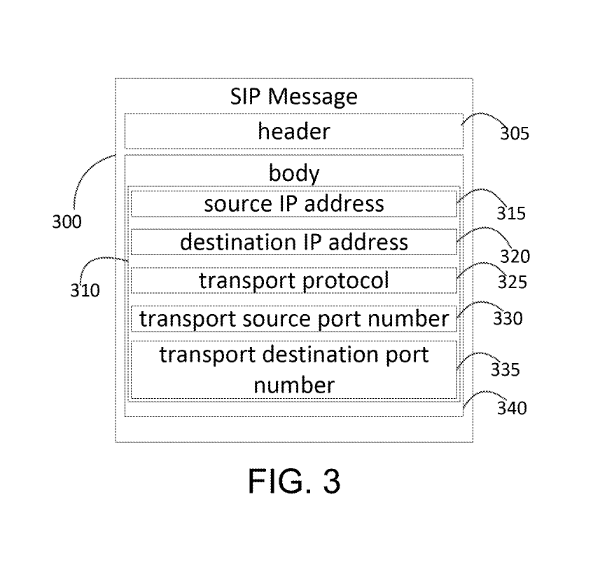

FIG. 3 illustrates Session Initiation Protocol (SIP) message 300 according to an example embodiment. SIP message 300 may be included in an SIP packet that is used to initiate, maintain, or terminate an SIP session. As shown in FIG. 3, SIP message 300 includes header 305 and body 340. Message body 340 may include tuple 310 (as shown) and/or several other fields (not shown). Additionally, tuple 310 may include source IP address 315, destination IP address 320, transport protocol 325, transport source port number 330, and transport destination port number 335.

In various embodiments, SIP message 300 may be a SIP request or SIP response. In such embodiments, header 305 may have a field that indicates a message type (i.e., request or response) of SIP message 300 (not shown). SIP requests and SIP responses may be used during SIP transactions. A SIP transaction is made up of a request sent by a user agent (e.g., user agents 105a-e) and of zero or more responses to the request sent by a SIP server (e.g., SIP server 140). All transactions are independent from each other. However, some can be used to set up a “dialog”. Transactions within a dialog are linked, such that a dialog may be thought of as a sequence of transactions. For example, a phone call is a dialog, where in addition to calling, one must hold, or hang up.

SIP requests (which initiate a transaction) may include INVITE (a message sent systematically by a user agent for any connection request); ACK (message sent by a user agent to end and to confirm the connection request); BYE (terminates a call, RTP packet exchange is stopped); CANCEL (terminates a call currently being set up); SUBSCRIBE—NOTIFY (message used to subscribe to/notify an event (e.g., a new voicemail message)); REGISTER (message sent by a user agent to indicate the user agent's actual address. This information can be stored in the SIP server and is used for call routing); REFER (message requesting a user agent to call an address (used for transfers)); and INFO (a SIP INFO message that generates DTMF tone for SIP requests). In various embodiments, the first four characters of the SIP requests may be used, such that the character patterns are limited to “INVI”, “BYE”, “UPDA”, “PRAC”, “ACK”, and “SIP/”, for example.

SIP responses (which acknowledge a transaction) may include informational (indicating that a transaction is in progress), success (indicating that a transaction has been completed successfully), forward (indicating that a transaction has been terminated and prompts the user agent to try again in other conditions), and errors (indicating that the transaction has unsuccessfully terminated).

Header 305 may also include other fields that may describe a format and/or a size of body 340 (not shown).

SIP message 300 may include body 340. Body 340 may include tuple 310, which may be an ordered list of elements, or a series of digits. In this context, the digits may be arranged at discrete positions, also known as fields. As shown in FIG. 3, tuple 310 may include source IP address 315, destination IP address 320, transport protocol 325, transport source port number 330, and transport destination port number 335. Accordingly, each one of IP address 315, destination IP address 320, transport protocol 325, transport source port number 330, and transport destination port number 335 may be represented by one or more digits. Additionally, the tuple values may be used in order to ensure that a SIP message will transit through all the SIP entities that processed the request. Furthermore, each one of IP address 315, destination IP address 320, transport protocol 325, transport source port number 330, and transport destination port number 335 may be formatted or otherwise defined by protocols such as TCP/IP, UDP, or other like OSI layer 4 protocols.

In various embodiments, body 340 may include other data fields (not shown). Body 340 may use data fields to describe parameters for transmitting a data stream, and to describe the characteristics of the data being sent during the stream. One or more fields may be used to describe a service or media to be transmitted during an SIP session. A service type field may denote the type of service to be used during a SIP session. The service type may be one of audio, video, data, and dual-tone multi-frequency signaling (DTMF). Other fields in body 340 may describe the parameters of the session and/or describe the timing of the session. In various embodiments, body 340 may be formatted according to the Session Description Protocol (SDP).

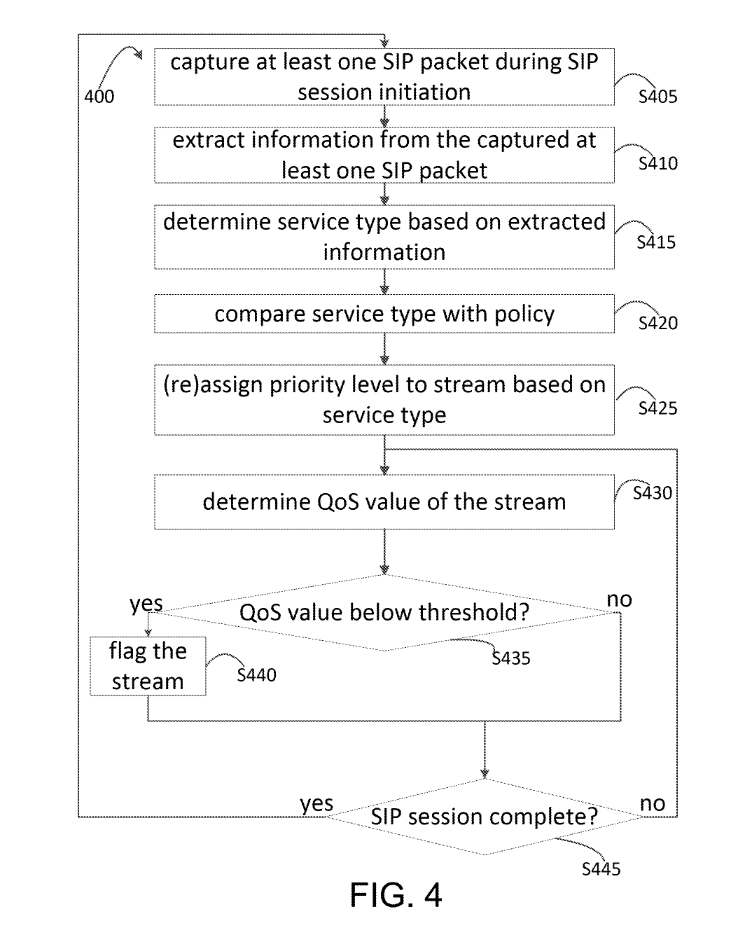

FIG. 4 shows a SIP snooping routine according to an example embodiment. SIP snooping routine may be used to monitor SIP sessions to identify one or more streams to be transmitted during the SIP session, and to adjust network parameters according to the type of stream being transmitted. For illustrative purposes, the operations of SIP snooping routine will be described as being performed by network device 200. However, it should be noted that any one of the network devices as shown in FIG. 1 (e.g., edge switches 110a-b, aggregate switches 120a-b, and core switches 130a-b), or other like network devices, may operate the SIP snooping routine as described below.

As shown in step S405, network device 200 captures at least one SIP packet. As described above, an SIP session may be initiated, maintained, or terminated by sending a SIP message from one user agent to another. To initiate a communication session, a first user agent sends a communication request to a SIP server (e.g., SIP server 140). The communication request includes a unique ID of a second user agent. The SIP server correlates the unique ID of the second user agent with an IP address of the second user agent, and then forwards the request to the second user agent. Upon receipt of the communication request by the second user agent, the first user agent and second user agent setup a communication session. Once the communication session is setup, the two clients transfer data using a direct peer-to-peer session. Therefore, in step S405, network device 200 captures at least one SIP packet during the SIP session initiation in order to extract information from the at least one SIP packet, as shown in step S410.

In various embodiments, at step S405, network device 200 may locally store the captured at least one SIP packet (not shown) or store the at least one captured SIP packet on a remote computer readable storage medium (not shown). In such embodiments, network device 200 may end up storing several SIP packets representing several streams being transmitted over a communications network. By storing these SIP packets over time, network device 200 may create and maintain a map that describes the flow of network traffic for specific types of traffic (e.g., for specific media types). Accordingly, a network administrator may use such a map to identify and troubleshoot network related problems or issues. Such a map may also be used to configure the network to produce a more efficient use of bandwidth.

In alternate embodiments (not shown), network device 200 may monitor the stream during the SIP session and capture at least one stream packet. As described above, the SIP packet only initiates, maintains, or terminates a SIP session between user agents and negotiates communication parameters. SIP uses another standard communication protocol (e.g., RTP/RTCP, IPv4, IPv6, or other like protocols) to transmit the stream. Thus, network device 200 may be configured to monitor the stream while it is being transmitted using the other communication protocol. Monitoring the stream may allow a network administrator to identify and troubleshoot network related problems or issues.

For example, the other communication protocol used to transmit the stream may be RTP/RTPC. RTP defines a standardized packet format for delivering audio and video over a communications network RTP is used in conjunction with the RTCP. While RTP carries the media streams (i.e., the voice, video, mission critical data), RTCP is used to monitor transmission statistics and QoS indicators, in addition to aiding the synchronization of multiple streams. Thus, network device 200 may be configured to capture at least one of the packets making up the stream being monitored.

As discussed above, network device 200 may include one or more data ports. According to various embodiments, network device 200 may be enabled to monitor all of its ports (referred to as monitoring globally). In such embodiments, network device 200 may be configured to automatically detect or identify which ports are being used for transmitting and/or receiving streams. In other embodiments, network device 200 may be configured to monitor specific ports. In such embodiments, a network administrator may determine which ports network device 200 should monitor.

As shown in step S410, network device 200 extracts information from the captured at least one SIP packet. As discussed above with regards to FIG. 3, SIP messages (e.g., SIP message 300) may include information regarding the data transfers that may occur during a SIP session. Thus, in step S410, network device 200 may extract information from the captured at least one SIP packet.

As shown in step S415, network device 200 determines a service type based on the extracted information. As discussed above, SIP packets may include information about the data being streamed. In step S415, network device 200 may extract information relating to the service type of the SIP packet from the body of the SIP packet. In various embodiments, network device 200 may extract other data from the captured at least one SIP packet. For example, as discussed above, SIP packets may contain tuple values that may a include source IP address (e.g., include source IP address 315), a destination IP address (e.g., destination IP address 320), a transport protocol (e.g., transport protocol 325), a transport source port number (e.g., transport source port number 330), and a transport destination port number (e.g., transport destination port number 335). According to such embodiments, at step S415, network device 200 may extract tuple values from the captured at least one SIP packet (not shown).

As shown in step S420, network device 200 compares the service type with a policy. As is known, a network policy may be one or more sets of conditions, constraints, and settings that designate or otherwise authorize certain user agents to connect to the network and the circumstances under which the user agents can or cannot connect to the network. According to various embodiments, a policy may define, designate or otherwise authorize certain trusted network devices that may be a part of the network. A group of these trusted network devices may comprise a “trusted domain”. Nodes in such a trust domain are explicitly trusted by its user agents and end-systems to publicly assert the identity of each party, and to be responsible for withholding that identity outside of the trust domain when privacy is requested. In such embodiments, the policy may define specific behaviors for nodes within the trusted domain, such as a manner in which user agents are authenticated, mechanisms used to secure communications between or among the nodes in the trusted domain, mechanisms used to secure communications between or among user agents and the nodes in the trusted domain, a manner used to determine which hosts are part of the trusted domain, and/or mechanisms used to define communications as “private”.

According to various embodiments, the policy may also define mechanisms for assigning priority levels to streams. A priority level may be any type of indication by which streams are given access to network resources, such that streams with a higher priority are given access to network resources before lower priority streams. A policy may differentiate between streams originating from (or being sent to) a node within the trusted domain and streams originating from (or being sent to) nodes outside of the trusted domain. In such embodiments, the policy may define priority levels to streams according to the service type of the stream (e.g., the service type determined in step S420), or based on the source or destination of the stream (e.g., one or more determined tuple values).

As shown in step S425, network device 200 assigns or reassigns a priority level to the stream based on the service type. As discussed above, the policy may define priority levels to streams according to the service type of the stream (e.g., the service type determined in step S415). Accordingly, in step S425, network device 200 assigns a priority level to the stream based on the service type of the stream and according to definitions set forth in the policy. Accordingly, network device 200 is configured to edit, change, or otherwise manipulate the data contained within a stream packet in order to assign such a priority level to the stream (assigning a priority level to one or more packets of a stream is sometimes referred to as “marking” packets or marking a stream).

For example, assume a policy specifies that a video stream should receive a higher priority level than a stream carrying mission critical data. In such instances, if SIP packet information of a captured SIP packet indicates that the stream is a video stream, network device 200 will assign a higher priority value to that stream, and assign a lower priority level to streams whose SIP packet information indicates that the stream contains mission critical data.

In various embodiments, a stream may have previously been marked with a priority level. For example, the DSCP protocol operates on the principle of traffic classification, where each data packet is placed into a limited number of traffic classes. Typically, traffic is differentiated based on a port number or a protocol being used by the stream. Thus, in a typical network, each stream is assigned a priority level based on the traffic class of the stream. Therefore, in such embodiments, network device 200 is configured to override the previously assigned priority level based on traffic class, and reassign a new priority level to the stream according to the policy. Additionally, in various embodiments, if the policy does not specify a priority level for a port or protocol, then the previously assigned priority level is not overridden.

According to various embodiments, the policy may define priority levels based on tuple values. As discussed above, at step S415, network device 200 may determine tuple values from the captured at least one SIP packet (not shown). In such embodiments, network device 200 may be configured assign a priority level to a stream based on one or more tuple values (not shown). For example, assume that a policy specifies that a stream originating from a trusted node should receive a higher priority level than a stream originating from an untrusted node. In such instances, if a source IP address contained with a tuple (e.g., source IP address 315) of a stream indicates that the stream is from a node within the trusted domain, then network device 200 may assign a higher priority level to that stream, and assign a lower priority level to a stream whose tuple indicates that the stream originates from an untrusted node. According to various embodiments, the policy may define priority levels based on a virtual LAN (VLAN), a source media access control (MAC) address, and/or a destination MAC address.

As shown in step S430, network device 200 determines a QoS value of the stream. QoS for networks is a set of standards and mechanisms for ensuring high-quality performance for critical applications. By using QoS mechanisms, network administrators can use existing resources efficiently and ensure a required level of service without reactively expanding or over-provisioning network resources. Network administrators can use QoS treatments to guarantee throughput for mission-critical applications so that transactions can be processed in an acceptable manner. Network administrators can also use QoS to manage streams using certain protocols, such as User Data Protocol (UDP) traffic or Real-time Transport Protocol (RTP). Typically, QoS of a stream is affected by various factors in a network causing such issues as low throughput, dropped packets, delay (or latency), out-of-order delivery, delay, jitter, round trip time (RTT), and the like. Accordingly, these factors can be measured for a stream and then used to compute a QoS value for the stream.

Additionally, different QoS measurements may be desired or required for certain types of network traffic. For example, one type of QoS measurement may be desired or required for video streams, as opposed to voice or audio streams. Therefore, the service class of a stream may determine one or more QoS treatments the stream receives. QoS treatments for packet-switched networks may include measuring delay, jitter, round trip time (RTT), R-factor, or mean opinion score (MOS).

Delay (also referred to as “latency”) is the delay in data transmission from source to destination. Delay may be caused by one or more packets being scheduled in a long queue, or from taking a less direct route to avoid congestion. Delay may also build up over time, such that, excessive delay can render an application unusable. As is known, there may be several methods of measuring delay (which is beyond the scope of this invention, and therefore will not be described in detail herein).

Jitter is the variability of packet latency across a network over a period of time. In various embodiments, jitter may be expressed as an average of the deviation from the network mean latency. As is known, there may be several methods of measuring jitter (which is beyond the scope of this invention, and therefore will not be described in detail herein).

R-factor and MOS are each a measure of voice quality of a VoIP stream that may occur during a SIP session. The MOS indicates the perceived voice quality of a VoIP conversation, ranking the call quality as a number in the range 1 to 5. R-Factor is an alternative method of assessing call quality that is scaled from 0 to 120. R-Factor is calculated by evaluating user perceptions as well as objective factors that affect the overall quality of a VoIP system. As is known, there may be several methods of measuring MOS and/or R-Factor (which is beyond the scope of this invention, and therefore will not be described in detail herein). Additionally, as is known, there may be several methods of correlating MOS with an R-factor (which is beyond the scope of this invention, and therefore will not be described in detail herein).

RTT is the length of time it takes for a signal or packet to be sent plus the length of time it takes for an acknowledgment of that signal or packet to be received. According to various embodiments, network device 200 may be configured to determine the RTT by summing a measure of time for at least one packet to be received by a user agent and a measure of time for an acknowledgement message sent by the user agent to be received by network device 200. As is known, there may be several other methods of measuring RTT (which is beyond the scope of this invention, and therefore will not be described in detail herein)

Additionally, many networking protocols provide for QoS information (or markings) to be included in a stream packet. For example, DSCP marks packets with a priority level according to a traffic class, which may indicate a desired QoS treatment. By way of another example, the RTCP protocol provides QoS statistics of a stream by periodically sending statistics information to participants in a streaming multimedia session. RTCP provides these statistics by marking RTCP packets with a QoS value. Thus, in step S435, network device 200 may determine the QoS value of a stream based on the DSCP and/or RTCP markings.

As shown in step S435, network device 200 determines if the QoS value is below a threshold. If so, the stream is flagged, as shown in step S440. According to various embodiments, QoS thresholds may be predefined by a network administrator.

According to various embodiments, flagging a stream may involve generating or otherwise defining a database record or other like file that contains information regarding a QoS value for a stream dropping below the threshold. For example, such a database record or file may record a QoS treatment being applied to a stream, user agent identification information (e.g., source IP address or other like information), the service type of the stream, and/or other stream-related information. Additionally, as discussed above with respect to step S405, network device 200 may create and maintain a map that describes the flow of network traffic for specific types of traffic (e.g., for specific media types) by storing SIP packets over time. According to various embodiments, such a map may include the flagged streams as recorded in a database record or other like file. Accordingly, a network administrator may use such a map that includes the flagged streams to identify and troubleshoot network related problems or issues. Such a map may also be used to configure the network to produce a more efficient use of bandwidth, such that QoS values are less likely to drop below the predefined threshold.

Once the stream is flagged, network device 200 determines if the SIP session is complete, as shown in step S445. According to various embodiments, network device 200 monitors the stream to ascertain whether a SIP message terminating the SIP session has been sent from one user agent to another. In the event that network device 200 does not intercept or otherwise capture a SIP message terminating the SIP session, network device 200 may determine that the SIP session is terminated if stream packets are no longer being sent, or if stream packets have not been communicated during a predefined period of time.

If at step S445, network device 200 determines that the SIP session is complete, network device 200 loops back to step S405 to capture at least one SIP packet during SIP session initiation of a new SIP session. If network device 200 determines that the SIP session is not complete, network device loops back to step S430 to determine a QoS value of the stream.

Referring back to step S435, if the QoS value is not below a threshold, network device 200 determines if the SIP session is complete, as shown in step S445 (as discussed above). If so, network device 200 loops back to step S405 to capture at least one SIP packet during SIP session initiation of a new SIP session. If network device 200 determines that the SIP session is not complete, network device loops back to step S430 to deter mine a QoS value of the stream.

As will be appreciated, the method and apparatus according the example embodiments has several advantages. First, the example embodiments allow for the detection of dynamic streams by snooping ongoing SIP sessions, such that priority levels may be automatically assigned to the streams and QoS treatments are automatically applied to the streams. Second, the example embodiments allow for easy implementation because a network administrator may delineate a policy that defines priority levels for streams according to a plurality of service types. Third, the example embodiments utilize the existing QoS-based technology, and hence additional processing is minimal.

The invention being thus described, it will be obvious that the same may be varied in many ways. Such variations are not to be regarded as a departure from the invention, and all such modifications are intended to be included within the scope of the present invention.

We claim:

1. A method for assigning a priority level to a stream by a network element in a communications network, the network element including a plurality of communications ports, the method comprising:
monitoring, by the network element, at least one of the plurality of ports for at least one stream being communicated between a first user agent and a second user agent during a Session Initiation Protocol (SIP) communication session, the SIP communication session including a plurality of SIP packets;
capturing, by the network element, at least one SIP packet of the plurality of SIP packets;
extracting, by the network element, information from the at least one captured SIP packet to determine a service type of the at least one stream; and
assigning, by the network element, a priority level to the at least one stream based on the service type and according to a policy that defines priority levels for streams according to a plurality of service types.

2. The method of claim 1, further comprising:
one of terminating and throttling the at least one stream based on the service type and according to the policy.

3. The method of claim 1, further comprising:
extracting quality of service (QoS) information from the stream to determine a QoS value, the QoS value being measured according to the service type of the stream.

4. The method of claim 3, further comprising:
flagging the stream when the QoS value falls below a predefined threshold.

5. The method of claim 4, wherein the QoS information is associated with a QoS type, the QoS type being one of a delay, a jitter, a round trip time (RN), an R-factor, and a mean opinion score (MOS),
the R-factor and MOS each being a measure of voice quality during the SIP session, and
the RTT being a sum of a measure of time for at least one packet sent by the network element to be received by a user agent and a measure of time for an acknowledgement message sent by the user agent to be received by the network element.

6. The method of claim 1, wherein each packet of the plurality of SIP packets comprises a tuple whose values include a source IP address, a destination IP address, a transport protocol, a transport source port number, and a transport destination port number.

7. The method of claim 6, wherein the assigning includes overriding the priority of the stream and assigning a new priority to the stream based on at least one tuple value and the service type, the new priority being assigned according to the policy.

8. The method of claim 1, wherein
the policy is created and maintained by a network administrator,
the service type is one of audio, video, data, and dual-tone multi-frequency signaling (DTMF), and
the stream is formatted according to the Real-time Transport Protocol (RTP).

9. A network device having a plurality of communications ports, the network device being part of a communications network, the network device configured to:
monitor at least one of the plurality of ports for a stream being communicated between a first user agent and a second user agent during a Session Initiation Protocol (SIP) communication session, the SIP communication session including a plurality of SIP packets;
capture at least one SIP packet of the plurality of SIP packets;
extract information from at least one SIP packet of the plurality of SIP packets to determine a service type of the stream; and
assign a priority level to the stream based on the service type and according to a policy that defines priority levels for streams according to a plurality of service types.

10. The device of claim 9, further configured to:
terminate or throttle the at least one stream based on the service type and according to the policy.

11. The device of claim 9, further configured to:
extract quality of service (QoS) information from the stream to determine a QoS value, the QoS value being measured according to the service type of the stream.

12. The device of claim 10, further configured to:
flag the stream when the QoS value falls below a predefined threshold.

13. The device of claim 10, wherein each of the plurality of QoS values is associated with a QoS type, the QoS type being one of a delay, a jitter, a round trip time (RTT), an R-factor, and a mean opinion score (MOS),
the R-factor and MOS each being a measure of voice quality during the SIP session, and
the RTT being a sum of a measure of time for at least one packet sent by the network element to be received by a user agent and a measure of time for an acknowledgement message sent by the user agent to be received by the network element.

14. The device of claim 9, wherein each packet of the plurality of SIP packets comprises a tuple that includes a source IP address, a destination IP address, a transport protocol, a transport source port number, and a transport destination number.

15. The device of claim 14, wherein the assigning includes overriding the priority of the stream and assigning a new priority to the stream based on at least one tuple value and the service type, the new priority being assigned according to the policy.

16. The method of claim 9, wherein
the policy is created and maintained by a network administrator,
the service type is one of audio, video, data, and dual-tone multi-frequency signaling (DTMF), and
the stream is formatted according to the Real-time Transport Protocol (RTP).
